(19) United States
(12) Patent Application Publication
(10) Pub. No.: US 2026/0208826 A1
(43) Pub. Date: Jul. 23, 2026

(54) MARINE VESSEL, METHOD, AND A FUEL TANK

(71) Applicant: WÄRTSILÄ FINLAND OY, Vaasa (FI)

(72) Inventors: Malgorzata KOCZUR, Vaasa (FI); Rasmus NYBO, Vaasa (FI); Szymon BIEROWIEC, Vaasa (FI)

(73) Assignee: WÄRTSILÄ FINLAND OY, Vaasa (FI)

(21) Appl. No.: 19/144,178

(22) PCT Filed: Dec. 30, 2022
(86) PCT No.: PCT/FI2022/050880

§ 371 Date: Jun. 27, 2025

(51) Int. Cl. B63B 17/00; B63B 79/10; F17C 13/06

(52) U.S. Cl. CPC B63B 17/0027; B63B 79/10; F17C 13/06; F17C 2201/0109; F17C 2201/035; F17C 2201/052; F17C 2201/054; F17C 2203/0617; F17C 2205/0142; F17C 2205/0311; F17C 2221/032; F17C 2223/0153; F17C 2260/038; F17C 2270/0105

(57) ABSTRACT

The disclosure relates a fuel tank for a marine vessel. The fuel tank including a gas tight manhole on an upper portion of the fuel tank and configured to be accessed from above the fuel tank in a use position of the fuel tank. The fuel tank is a single shell fuel tank including a tank connection space provided at an end or on a side of the fuel tank, which tank connection space includes a gas tight compartment containing tank penetrations and tank valves for fuel. A secondary enclosure covers the manhole and limits a first space between the manhole and the secondary enclosure forming a gas tight compartment isolating the first space from a tank hold space. An entrance to the tank connection space is provided through a second space. Ventilation is provided the secondary enclosure, the tank connection space and the second space.

### BACKGROUND

The present disclosure relates to marine vessels, and more particularly to a fuel tank and a method in connection with a marine vessel.

Fuels used in marine vessels, such as hydrocarbon gas or ammonia, may be harmful and/or explosive as such or cause harmful and/or explosive mixtures or compounds to be formed for instance with air. This has to be considered, when structures for holding such fuels, such as fuel tanks, are designed. Especially all penetrations, such a pipelines, instrumentations, and manholes, made to shells of fuel tanks are considered to be potential risk areas for leakages.

### BRIEF DESCRIPTION OF THE DISCLOSURE

An object of the present disclosure is to provide a new fuel tank, marine vessel, and a method.

The object of the disclosure is achieved by a method and an arrangement which are characterized by what is stated in the independent claims. Some embodiments of the disclosure are disclosed in the dependent claims.

The disclosure is based on a technical structure, where a gas tight, ventilated secondary enclosure is provided to surround a gas tight manhole of a fuel tank of a marine vessel, which secondary enclosure is separate from a tank connection space of the fuel tank.

An advantage of the method and arrangement of the disclosure is that a fuel tank can be provided which has a more compact size and especially a lower structure compared to fuel tanks, in which the manhole is provided inside a tank connection space.

### BRIEF DESCRIPTION OF THE DRAWINGS

In the following the disclosure will be described in greater detail by means of preferred embodiments with reference to the accompanying drawings, in which

FIG. 1 illustrates schematically a fuel tank according to an embodiment seen from a side;

FIG. 2 illustrates schematically a detail of a fuel tank according to an embodiment seen in a cross section from a direction of an end of the fuel tank;

FIG. 3 illustrates schematically a detail of a fuel tank according to an embodiment seen in a partial cross section from a direction of an end of the fuel tank;

FIG. 4 illustrates schematically a shape of a fuel tank according to an embodiment seen from a side;

FIG. 5 illustrates schematically a shape of a fuel tank according to an embodiment seen from an end;

FIG. 6 illustrates schematically a marine vessel according to an embodiment;

FIG. 7 illustrates schematically a marine vessel according to an embodiment in a cross section seen from a side;

FIG. 8 illustrates schematically a marine vessel according to a further embodiment seen in cross section from an end; and

FIG. 9 illustrates schematically a method in connection with a marine vessel.

### DETAILED DESCRIPTION OF THE DISCLOSURE

The disclosure relates to a fuel tank for a marine vessel, a marine vessel, and a method in connection with a marine vessel.

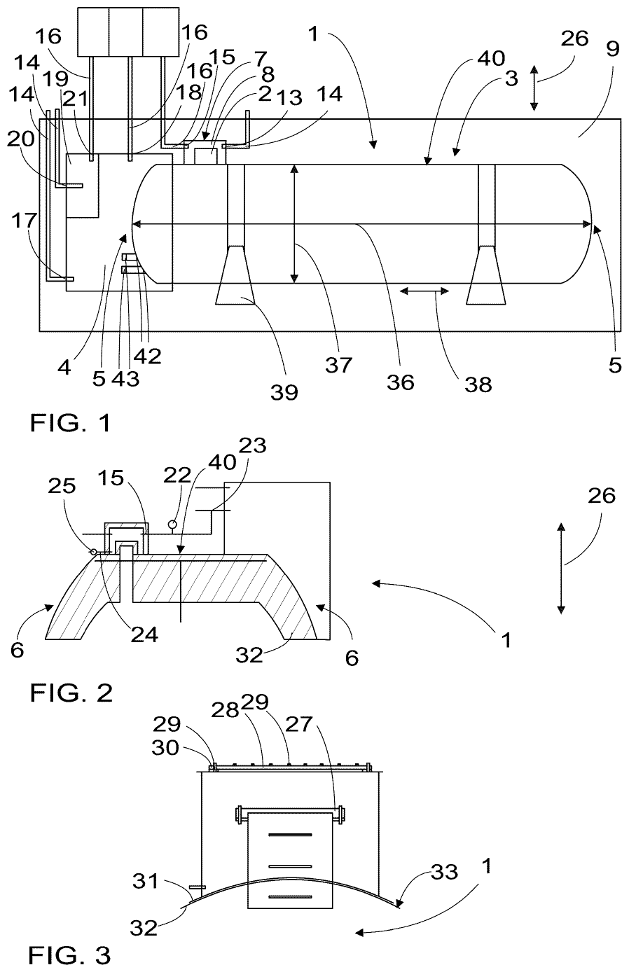

FIG. 1 illustrates schematically a fuel tank according to an embodiment seen from a side, and FIG. 2 illustrates schematically a detail of a fuel tank according to an embodiment seen in a cross section from a direction of an end of the fuel tank.

A fuel tank 1 for a marine vessel 10, which marine vessel 10 comprises a hull 11 and a deck 12, comprises a gas tight manhole 2 provided on an upper portion 3 of the fuel tank 1. The fuel tank 1 may comprise for instance a hydrocarbon gas or ammonia fuel tank. The manhole 2, for instance in the embodiment of FIG. 1, is configured to be accessed from above the fuel tank 1 in a use position of the fuel tank 1 to provide access to the fuel tank 1. In other words, the manhole 2 is configured to enable an end user, such as a maintenance person, to access the manhole 2, and thereby the inside of the fuel tank 1 from above the fuel tank. The manhole 2 is, however, normally very rarely used to access the fuel tank 1, typically only during maintenance breaks.

A use position of the fuel tank 1 refers to a position of the fuel tank 1 when mounted to a marine vessel 10. More particularly, a use position of the fuel tank 1 refers to a position of the fuel tank 1 when mounted to a marine vessel 10 and when the marine vessel 10 is in a neutral position. Similarly, a use position of the marine vessel 10 refers to a position of the marine vessel 10 when the marine vessel 10 is in a neutral position. In other words, the use position of the fuel tank 1 or the marine vessel 10 does not refer to, for example, extreme positions of the fuel tank 1 or the marine vessel 10 in varying weather conditions.

The disclosed fuel tank 1 is a single shell fuel tank. The fuel tank 1 comprises a tank connection space 4 provided at an end 5 or on a side 6 of the fuel tank, which tank connection space 4 comprises a gas tight compartment containing tank penetrations 42 and tank valves 43 for fuel. In other words, tank penetrations 42 and tank valves 43 for fuel, preferably all tank penetrations 42 and tank valves 43 for fuel, are provided within the tank connection space 4. According to an embodiment, the fuel tank 1 comprises a tank connection space 4 provided at an end 5 of the fuel tank 1. A tank connection space 4 being provided at an end 5 of the fuel tank 1 refers to the tank connection space 4 covering at least a part of an end 5 of the fuel tank 1. In other words, the tank connection space 4 may be partly limited, for instance on one side of the tank connection space 4, by the end 5 of the fuel tank 1. According to an embodiment, a tank connection space 4 provided at an end 5 of the fuel tank 1 may cover the entire end 5 of the fuel tank 1 and only the end 5 of the fuel tank 1, in other words not extending to the sides 6, above the fuel tank 1, or below the fuel tank 1, more particularly the one or both of the sides 6, above or below the shell 32 of the fuel tank 1. According to an embodiment, a tank connection space 4 provided at an end 5 of the fuel tank 1 may cover the entire end 5 of the fuel tank 1 and, in addition, extend to an area of at least one of the following: a side 6 of the fuel tank 1, both sides 6 of the fuel tank 1, above the shell 32 of the fuel tank 1, and below the shell 32 of the fuel tank 1. According to an embodiment, a tank connection space 4 provided at an end 5 of the fuel tank 1 may cover the entire end 5 of the fuel tank 1 and, in addition, extend to area of at least one side 6 of the fuel tank 1 and also extend above and/or below the shell 32 of the fuel tank 1. According to an embodiment, a tank connection space 4 provided at an end 5 of the fuel tank 1 may only cover a portion of an end 5 of the fuel tank 1 and only the portion of the end 5 of the fuel tan 1. According to an embodiment, a tank connection space 4 provided at an end 5 of the fuel tank 1 may cover a portion of an end 5 of the fuel tank 1 and, in addition, extend to area of at least one of the following: a side 6 of the fuel tank 1, both sides 6 of the fuel tank 1, above the shell 32 of the fuel tank 1, and below the shell 32 of the fuel tank 1. The tank connection space 4 being provided on a side 6 of the fuel tank 1 refers to the tank connection space 4 covering at least a part of a side 6 the fuel tank 1. In other words, a tank connection space 4 provided on a side 6 of the fuel tank 1 may, in addition to covering the part of the side 6, extend above the shell 32 of the fuel tank 1 and/or below the shell 32 of the fuel tank 1. Such embodiments may be beneficial, as a fuel tank 1 of a compact size can be provided, and especially the height and the width of the fuel tank can be kept to a minimum.

In addition, the fuel tank 1 is provided with a secondary enclosure 7 covering the manhole 2 and limiting a first space 8 between the manhole 2 and the secondary enclosure 7 for providing access to the manhole 2. In other words, the secondary enclosure 7 is configured to cover the manhole 2. Thereby, the secondary enclosure 7 is further configured to limit the first space 8 provided between the manhole 2 and the secondary enclosure 7. The first space 8 extends at least around and above of the manhole 2 and forms, when closed, a gas tight compartment isolating the first space 8 from a tank hold space 9. The manhole 2 and the secondary enclosure 7, thus, provide a double protection for the access to the inside of the fuel tank 1, as the inside of the fuel tank 1 is configured to be accessed first through the secondary enclosure 7 and then through the manhole 2, both providing gas tight structures when closed, and a space, the first space 8, limited between them.

The tank hold space 9 comprises a space that surrounds the fuel tank 1, the tank connection space 4, and the secondary enclosure 7. According to an embodiment, the fuel tank 1 is provided under the deck 12 under the deck, and the tank hold space 9 comprises a space that surrounds the fuel tank 1, the tank connection space 4, and the secondary enclosure 7.

According to an embodiment, the manhole 2 and the secondary enclosure 7 both comprise a gas tight cover 27, 28, respectively. This is best seen in FIG. 3, which FIG. 3 illustrates schematically a detail of a fuel tank according to an embodiment seen in a partial cross section from a direction of an end of the fuel tank. The manhole cover 27 and the secondary enclosure cover 28 being gas tight refers to the manhole cover 27 and the secondary enclosure cover being configured to be gas tight. The gas tight secondary enclosure 7 and the ventilation of the first space 8 are provided to ensure safety also in case of a leak in the gas tight structure.

According to an embodiment, the gas tight manhole cover 27 and the gas tight secondary enclosure cover 28 may be provided one after the other in the direction of travel in a spaced manner. The direction of travel refers to the direction in which the manhole 2 is configured to be accessed via the secondary enclosure 7. According to an embodiment, the manhole cover 27 and the secondary enclosure cover 28 are provided on top of each other in a vertical direction 26.

According to an embodiment, at least the secondary enclosure cover 28 comprises a maintenance hatch, which maintenance hatch is mounted to the rest of the secondary enclosure 7 by bolts 29 in a locked manner. According to an embodiment, at least one of the bolts 29 is locked in a closed position by welding. In other words, the maintenance hatch may be mounted to the rest of the secondary enclosure 7 in a locked manner by locking at least one bolt 29 in a closed position by welding. According to an embodiment, the secondary enclosure cover 28 comprises, in addition to or instead of at least one bolt 29 locked in a closed position, a separate locking device (not shown) for locking the cover to a closed position. In other words, the maintenance hatch may be mounted to the rest of the secondary enclosure 7 in a locked manner by a separate locking device. Such a locking device may comprise for instance a lock, such as a padlock type of a lock, with a specific key only accessible by authorized persons.

According to an embodiment, the secondary enclosure cover 28 is mounted by a mounting flange 30 and bolts 29 mounted through the mounting flange 30.

According to an embodiment, the manhole cover 27 comprises a maintenance hatch similar to an embodiment or a combination of embodiments disclosed in connection with secondary enclosure cover 28. According to a further embodiment, the manhole cover 27 comprises a hatch welded to the rest of the manhole 2 structure instead of or in addition to being mounted by bolts.

According to an embodiment, the manhole cover 27 and/or the secondary enclosure cover 28 is designed to be removable or unmountable in one piece, but the removal or unmounting is configured to require special equipment, in other words equipment different from for instance equipment designed to unmount bolts and similar. In other words, the manhole 2 and the secondary enclosure 7 may be configured to be accessible, but the access requiring specific tools or equipment, or the ease of access being limited in some other way. According to an embodiment, the manhole cover 27 and/or the secondary enclosure cover 28 are designed to be re-mountable after being removed or unmounted. According to an embodiment, a welded locking of the manhole cover 27 and/or the secondary enclosure cover 28 may be configured to form a seal providing a visible indication of whether or not the cover 27, 28 in question has been opened.

The secondary enclosure 7 is provided with a first ventilation inlet 13 configured to connect the first space 8 to inlet ventilation piping 14 and a first ventilation outlet 15 configured to connect the first space to outlet ventilation piping 16. The secondary enclosure 7 and the manhole 2 are, thus, both formed as gas tight structures, and the first space 8 provided between the manhole 2 and the secondary enclosure 7 is ventilated via the first ventilation inlet 13 and the first ventilation outlet 15.

The tank connection space 4 is provided with a second ventilation inlet 17 configured to connect the tank connection space 4 to inlet ventilation piping 14 and a second ventilation outlet 18 configured to connect the tank connection space 4 to outlet ventilation piping 16.

An entrance to the tank connection space 4 is provided through a second space 19. The second space 19 comprises a gas tight compartment and is provided with a third ventilation inlet 20 configured to connect the second space 19 to inlet ventilation piping 14 and a third ventilation outlet 21 configured to connect the second space 19 to outlet ventilation piping 16.

According to an embodiment, ventilation is provided for the secondary enclosure 7, the tank connection space 4 and the second space 19. Preferably the ventilation to the secondary enclosure 7, the tank connection space 4 and the second space 19 is configured to be arranged and/or controlled separately in such a manner, that ventilation in each space 8, 4, 19 can be determined and controlled separately according to different needs and requirements. This may be provided by providing a separate ventilation inlet piping 14 and/or a separate ventilation outlet piping 16 for the secondary enclosure 7, the tank connection space 4, and the second space 19. Thus, despite using the same reference number for the ventilation inlet piping 14 and ventilation outlet piping 16, the ventilation inlet piping 14 and/or ventilation outlet piping 16 for each one of the secondary enclosure 7, the tank connection space 4, and the second space 19 may comprise separate pipes not connected to each other.

According to an embodiment, the outlet ventilation piping 16 is isolated from the tank hold space 9. In other words, the content of the outlet ventilation piping 16 is isolated from the tank hold space 9, which tank hold space surrounds the fuel tank 1, the tank connection space 4 and the secondary enclosure 7. According to an embodiment, the outlet ventilation piping 16 is configured to guide the outlet air from the first space 8, from the tank connection space 4, and from the second space 19, respectively, to outside air outside the tank hold space 9. Depending on the embodiment, the outlet ventilation piping 16 may comprise separate pipes, or lines, for outlet air from the first space 8, from the tank connection space 4, and from the second space 19, which separate pipes are not connected to each other in any way, or two or more of the pipes or lines connected to the first space 8, the tank connection space 4, and/or to the second space 19 may be connected to each other at a point within the tank hold space 9 or outside the hull 11 of the marine vessel 10.

According to an embodiment, the first space 8 and the tank connection space 4 share, at least partly, outlet ventilation piping 16. In other words, at least a portion of the outlet ventilation piping 16 connected to the first ventilation outlet 15 and the outlet ventilation piping 16 connected to the second ventilation outlet 18 may be connected to one pipe or line. According to an embodiment, a branch 23 connecting the ventilation outlet piping 16 connected to first ventilation outlet 15 and the ventilation outlet piping 16 connected to the second ventilation outlet 18 is provided downstream from the first ventilation outlet 15 and from the second ventilation outlet 18. In other words, the branch 23 connecting the ventilation outlet piping 16 connected to first ventilation outlet 15 and the ventilation outlet piping 16 connected to the second ventilation outlet 18 may be provided downstream from the first space 8 and from the tank connection space 4. Thereby, the branch 23 may be provided outside the first space 8 and the tank connection space 4.

According to an embodiment, the inlet ventilation piping 14 is isolated from the tank hold space 9. In other words, the content of the inlet ventilation piping 14 is isolated from the tank hold space 9. According to an embodiment, the inlet ventilation piping 14 is configured to guide the inlet air to the first space 8, to the tank connection space 4, and to the second space 19, respectively. Depending on the embodiment, the inlet ventilation piping 14 may comprise separate pipes, or lines, for inlet air to the first space 8, to the tank connection space 4, and to the second space 19, which separate pipes are not connected to each other in any way, or two or more of the pipes or lines connected to the first space 8, the tank connection space 4, and/or to the second space 19 may be connected to each other at a point within the tank hold space 9 or outside the hull 11 of the marine vessel 10.

According to an embodiment, the first space 8 and the tank connection space 4 share, at least partly, inlet ventilation piping 14. In other words, at least a portion of the inlet ventilation piping 14 connected to the first ventilation inlet 13 and the inlet ventilation piping 14 connected to the second ventilation inlet 17 may be connected to one pipe or line. According to an embodiment, a branch 23 connecting the ventilation inlet piping 14 connected to first ventilation inlet 13 and the ventilation inlet piping 14 connected to the second ventilation inlet 17 is provided upstream from the first ventilation inlet 13 and from the second ventilation inlet 17. In other words, the branch 23 connecting the ventilation inlet piping 14 connected to first ventilation inlet 13 and the ventilation inlet piping 14 connected to the second ventilation inlet 17 may be provided upstream from the first space 8 and from the tank connection space 4. Thereby, the branch 23 may be provided outside the first space 8 and the tank connection space 4.

According to an embodiment, the first space 8 is configured to be ventilated, namely to be ventilated via the first ventilation inlet 13 and the first ventilation outlet 15, at least 10 air changes per hour. In other words, an amount of air equal to at least 10 times the volume of the first space 8 may be provided to the first space 8 via the first ventilation inlet 13 and out from the first space 8 via the first ventilation outlet 15 in an hour. According to an embodiment, the first space 8 is configured to be ventilated, via the first ventilation inlet 13 and the first ventilation outlet 15, at least 30 air changes per hour. According to an embodiment, the first space 8 is configured to be ventilated, or ventilated, at least 10 air changes, and preferably at least 30 air changes, per hour continuously during normal operation of the fuel tank 1.

According to an embodiment, the ventilation comprises a suction-based ventilation. More particularly, the ventilation of the first space 8, the tank connection space 4 and/or the second space 19 may be configured to be provided in a suction-based manner. In other words, the ventilation may be arranged by suction, in other words under pressure, provided at the first ventilation outlet 15, the second ventilation outlet 18 and/or at the third ventilation outlet 21, rather than providing pressurized air to the first ventilation inlet 13, the second ventilation inlet 17, and/or the third ventilation inlet 20, respectively.

According to an embodiment, the first ventilation outlet 15 and/or the ventilation outlet piping 16 connected to the first ventilation outlet 15 is provided with a gas detector 22 configured to detect a leak from the fuel tank 1 to the first space 8. In other words, the gas detector 22 may be provided in fluid connection with the first ventilation outlet 15. This may be beneficial, as a leak from the fuel tank to the first space 8 may be detected early and safety may be ensured before a maintenance person enters the first space 8 for accessing the manhole 2 and/or the fuel tank 1.

According to an embodiment, the secondary enclosure 7 is provided with a drain 24 comprising a self-closing valve 25 for draining condensation water from the first space 8 using the self-closing valve 25. According to an embodiment, the self-closing valve 25 may comprise a cryogenic self-closing valve.

According to an embodiment, the manhole 2 is configured to be accessed in a vertical direction 26 from above the fuel tank 1 in the use position of the fuel tank 1. In other words, the manhole 2 may be configured to be accessed directly from above the manhole 2, or substantially directly from above the manhole 2.

According to another embodiment, the manhole 2 may be configured to be accessed in a direction angled with respect to a vertical direction 26 from above the fuel tank 1 in a use position of the fuel tank 1. In other words, the direction, in which the manhole 2 is configured to be accessed, may differ from a vertical direction by an angle (not shown). According to such an embodiment, the manhole 2 may be configured to be accessed in a direction with an angle of at most 45 degrees with respect to a vertical direction 26. Accessing the manhole 2 directly from above the manhole 2 in a vertical direction 26 or in a direction in the range of 0 to 45 degrees with respect to the vertical direction 26 may be beneficial for instance for safety of a maintenance person accessing the manhole.

According to an embodiment, the secondary enclosure 7 comprises a doubling plate 31 configured to be mounted against a shell 32 of the fuel tank 1, and to conform, at least partly, to a shape of a surface 33 of the shell 32 of the fuel tank 1. An example of such an embodiment is shown schematically in FIG. 3.

According to an embodiment, the fuel tank 1 is configured to hold liquified gas. According to an embodiment, the fuel tank 1 may be configured to hold hydrocarbon gas or ammonia.

According to an embodiment, the fuel tank is configured to meet the requirements of the relevant ATEX Directive, such as 2014/34/EU, such as the requirements for the relevant equipment category.

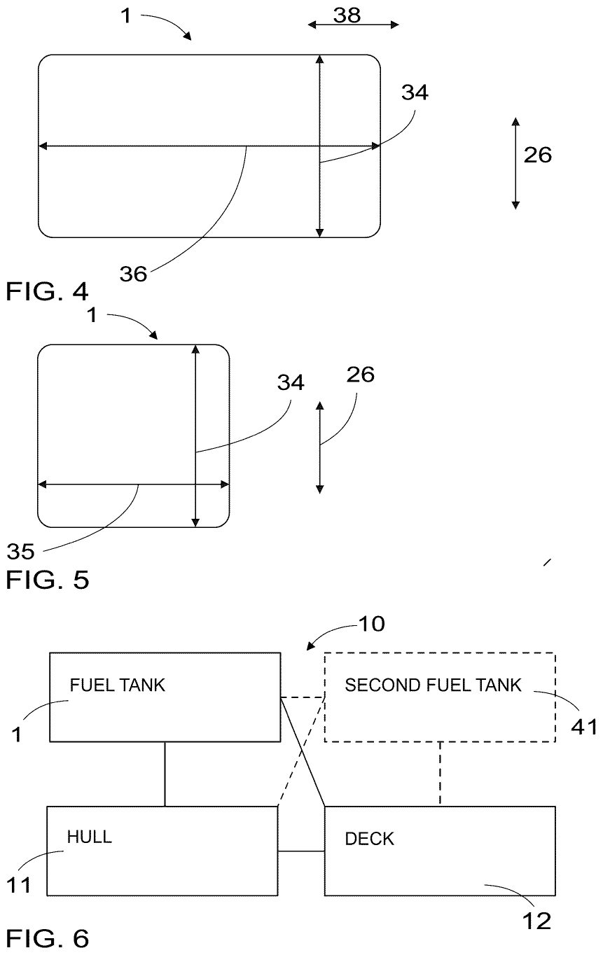

FIG. 4 illustrates schematically a shape of a fuel tank according to an embodiment seen from a side, and FIG. 5 illustrates schematically a shape of a fuel tank according to an embodiment seen from an end. In FIGS. 4 and 5 the shape resembles a rounded rectangular cuboid. However, fuel tanks 1 such as those disclosed in this disclosure may also comprise, and often may do, a round or oval shaped cross section instead of a rounded rectangle shown in FIG. 5. FIGS. 4 and 5 are, thus, provided to illustrate some features of shapes of fuel tanks 1 only, and the actual shape of the fuel tank 1 may also be different from that of FIGS. 4 and 5, such as in FIGS. 1, 2 and 3.

According to an embodiment, the fuel tank 1 has an elongated form. According to an embodiment, a maximum height 34 of the fuel tank 1 is smaller than or equal to 1.5 times the maximum width 35 of the fuel tank. According to an embodiment, a maximum height 34 of the fuel tank 1 is in the range of 0.5 to 1.5 times the maximum width 35 of the fuel tank. According to another embodiment, the maximum height of the fuel tank 1 is smaller than or equal to the maximum width 35 of the fuel tank 1. Such fuel tanks 1 may be beneficial, as they may be formed as relatively low in height and narrow in width with respect to the total internal volume of the fuel tank 1. Providing the relatively low manhole 2 and secondary enclosure 7 on the upper portion 3 of the fuel tank 1 and a separate tank connection space 4, which necessarily needs a larger inside space, at an end 5 of the fuel tank 1 further helps in achieving such an elongated shape of the fuel tank 1. A benefit of such elongated fuel tanks 1 is, for instance, that it is easy to position inside a marine vessel 10, as marine vessels 10 too typically have an elongated shape.

According to an embodiment, the fuel tank 1 has, at least partly, a form of a solid of revolution. In other words, at least a part of the fuel tank 1 may comprise a form of a solid of revolution. According to an embodiment, the inside of the shell 32 of the fuel tank 1, namely the volume of the fuel tank 1 configured to receive the fuel, may have a shape of a capsule, in other words a spherocylinder, or a peanut-like shape, which is narrower at a middle part. According to an embodiment, a longitudinal direction 38 of the fuel tank extends in the direction of the axis of the solid of revolution.

According to an embodiment, a maximum length 36 of the fuel tank 1 is in the range of 2 to 8 times a maximum diameter 37 of the fuel tank measured in a direction transverse to the longitudinal direction 38 of the fuel tank 1.

In this disclosure, the height 34 of the fuel tank 1 refers to the largest dimension of the fuel tank 1 in a vertical direction 26 in a use position of the fuel tank 1. Similarly, the width 35 of the fuel tank 1 refers to the largest dimension of the fuel tank 1 in a horizontal direction perpendicular to a longitudinal direction 38 of the fuel tank 1 in a use position of the fuel tank 1. The maximum diameter 37 may comprise the height 34 and/or the width 35 of the fuel tank 1, or a diameter measured in another direction perpendicular to the longitudinal direction 38 of the fuel tank 1 depending on the shape of the fuel tank and its cross section.

According to an embodiment, the fuel tank 1 is configured to be provided on support structures 39 for supporting the fuel tank 1. These support structures 39 may comprise structures provided as an integral part of the fuel tank 1 or the marine vessel 10, or as a separate structural part configured to be mounted to the marine vessel 10.

According to an embodiment, the longitudinal direction 38 of the fuel tank 1 is provided in a substantially horizontal direction in a use position of the fuel tank 1. According to an embodiment, the longitudinal direction 38 of the fuel tank 1 is provided in a substantially horizontal direction in a use position of the marine vessel 10.

According to an embodiment, the volume of the fuel tank 1 is in the range of 100-3000 m3. According to another embodiment, the volume of the fuel tank 1 is in the range of 300-2000 m3. According to a further embodiment, the volume of the fuel tank is at least 300 m3. In other words, the fuel tank 1 disclosed in this disclosure refers to a large fuel tank used in large marine vessels 10.

According to an embodiment, the secondary enclosure 7 is provided on an upper portion of the fuel tank 1. According to an embodiment, the secondary enclosure 7 may be provided on a top surface of the fuel tank. In other words, the secondary enclosure 7 may be provided on a level of the top central line 40 of the fuel tank 1. According to another embodiment, the secondary enclosure 7 may be provided on an upper portion of the fuel tank 1 extending 30 degrees on both sides of a top central line 40 of the fuel tank 1 parallel to the longitudinal direction 38 of the fuel tank 1. In other words, the secondary enclosure 7 is provided on the top surface of the fuel tank 1 and/or within a surface area of the fuel tank 1 extending a maximum of 30 degrees to one or both sides of the top central line 40 of the fuel tank 1.

According to an embodiment, at least a part of the fuel tank instrumentation (not shown) is provided within the first space 8. According to an embodiment, at least a part of the fuel tank instrumentation is provided within the tank connection space 4. In other words, at least a part of the fuel tank instrumentation may be provided within the first space 8 and/or within the tank connection space 4. According to an embodiment, no fuel tank instrumentation is provided within the first space 8. According to an embodiment, the fuel tank instrumentation may comprise at least one of level gauging and gas temperature measurement device. According to an embodiment, the fuel tank instrumentation may also comprise other instrumentation.

According to an embodiment, the fuel tank 1 is configured to hold liquified gas. According to an embodiment, the fuel tank 1 is configured to hold hydrocarbon gas or ammonia.

According to an embodiment, an access between the second space 19 and the tank connection space 4 may be bolted. According to an embodiment, the second space 19 may comprise a basic airlock space. According to an embodiment, access to the second space may be configured to be closed by a lock suitable for basic airlock spaces. Such embodiments may be beneficial, as there may typically be a more frequent need to access the tank connection space 4 than the first space 8, and it may also be necessary to access the tank connection space 4 during operation of the fuel tank 1.

According to an embodiment, the tank connection space 4 is configured to be accessed through the second space 19. According to an embodiment, access to the second space 19 and/or to the tank connection space 4 may be provided with a cover (not shown), such as a hatch or a door. According to an embodiment, the second space 19 and the tank connection space 4 both comprise a gas tight cover, and wherein the gas tight second space cover and the gas tight tank connection space cover are provided one after the other in the direction of travel in a spaced manner.

According to an embodiment, the second space cover and the tank connection space cover are provided on top of each other in a vertical direction. According to an embodiment, the second space cover and/or the tank connection space cover may comprise a maintenance hatch, which is mounted to the to the rest of the structure by bolts in a locked manner. According to an embodiment, at least one of the bolts is locked in a closed position by welding. According to an embodiment, the second space cover and/or the tank connection space cover may further comprise a separate locking device for locking the cover to a closed position.

According to an embodiment, the second space cover and/or the tank connections space cover may be mounted by a mounting flange and bolts mounted through the mounting flange.

According to an embodiment, the second space cover and/or the tank connection space cover is designed to be removable or unmountable in one piece. According to an embodiment, the removal or unmounting may be configured to require special equipment, in other words equipment different from for instance equipment designed to unmount bolts and similar. In other words, the second space 19 and the tank connections space 4 may be configured to be accessible, but the access requiring specific tools or equipment, or the ease of access being limited in some other way. According to an embodiment, the second space cover and/or the tank connection space cover may be designed to be re-mountable after being removed or unmounted. According to an embodiment, a welded locking of the second space cover and/or the tank connection space cover may be configured to form a seal providing a visible indication of whether or not the cover in question has been opened.

According to an embodiment, the tank connection space is configured to be accessed from an end 5 or a side 6 of the fuel tank 1.

According to an embodiment, the tank connection space 4 may be configured to be accessed from above the fuel tank 1. This may be beneficial considering the safety of the maintenance and operation personnel needing an access to the tank connection space 4.

According to an embodiment, the fuel tank 1 may comprise a cryogenic design.

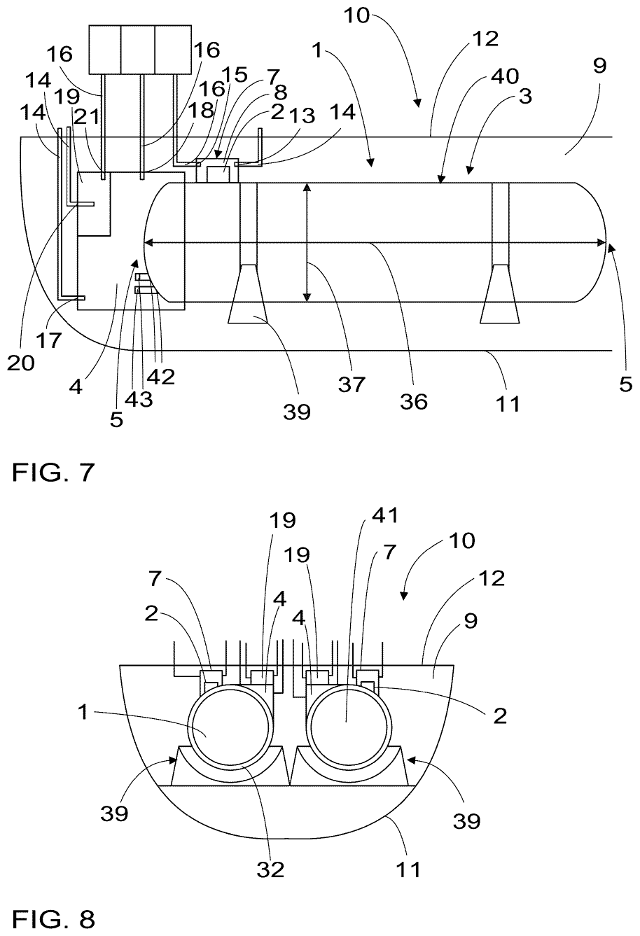

FIG. 6 illustrates schematically a marine vessel according to an embodiment, FIG. 7 illustrates schematically a marine vessel according to an embodiment in a cross section seen from a side, and FIG. 8 illustrates schematically a marine vessel according to a further embodiment seen in cross section from an end.

A marine vessel 10 may comprise a hull 11, a deck 12, and a fuel tank 1 according to an embodiment disclosed in this description and accompanying drawings and claims, or a combination of such embodiments. It is clear for a person skilled in the art that a marine vessel 10 comprises a high number of other structural and functional parts that are not relevant for this disclosure and are, thus, not disclosed here in more detail.

According to an embodiment, the fuel tank 1 may be provided within the hull 11 and below the deck 12 of the marine vessel 10. According to an embodiment, the marine vessel 10 may comprise, below the deck 12, a second fuel tank 41. According to an embodiment, the fuel tanks 1, 41 may be provided side by side. According to a further embodiment, the fuel tanks 1, 41 may share, at least partly, a common ventilation. According to an embodiment, the fuel tanks 1, 41 share, at least partly, the ventilation inlet piping 14 and/or the ventilation outlet piping 16. According to another embodiment, the ventilation inlet piping 14 of the first fuel tank 1 is completely separate from the ventilation inlet piping of the second fuel tank 41. Similarly, according to an embodiment, the ventilation outlet piping 16 of the first fuel tank 1 is completely separate from the ventilation outlet piping of the second fuel tank 41. In other words, the ventilation inlet piping 14 and/or the ventilation outlet piping 16 for the first fuel tank 1 and the second fuel tank 41 may be completely separate, shared or partly shared depending on the embodiment.

According to an embodiment, at least one fuel tank 1, 41 is configured to be provided on support structures 39 provided in the tank hold space 9 of the marine vessel 10 for supporting the fuel tank 1.

According to an embodiment, the entire tank hold space 9 is provided under the deck. In other words, the tank hold space 9 may be defined around the fuel tank(s) 1, 41, the tank hold space(s) 9, the secondary enclosure(s) 7 and the second space(s) 19, within the hull 11 and below the deck 12.

According to an embodiment, the marine vessel 10 comprises a marine vessel classified under IGF or IGC code.

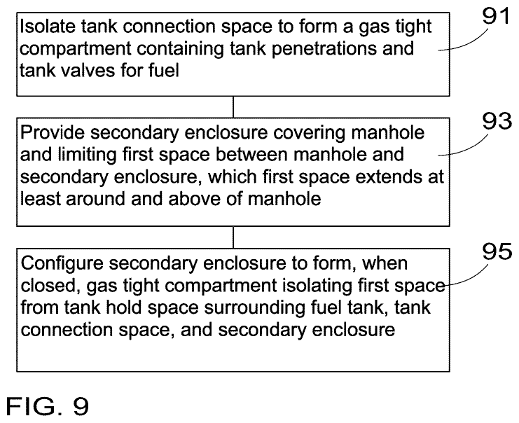

FIG. 9 illustrates schematically a method in connection with a marine vessel.

A method in connection with a marine vessel 10, which marine vessel 10 comprises a hull 11, a deck 12, and a fuel tank according to an embodiment disclosed in this description and accompanying drawings and claims, or a combination of such embodiments, may comprise isolating 91 the tank connection space 4 to form a gas tight compartment containing tank penetrations 42 and tank valves 43 for fuel. The method may also comprise providing 93 a secondary enclosure 7 covering the manhole 2 and limiting a first space 8 between the manhole 2 and the secondary enclosure 2, which first space 8 extends at least around and above of the manhole. The method may further comprise configuring 95 the secondary enclosure to form, when closed, a gas tight compartment isolating the first space 8 from a tank hold space 9, which tank hold space 9 surrounds the fuel tank 1, the tank connection space 4, and the secondary enclosure 7. According to an embodiment, tank hold space 9 may surround the fuel tank 1, the tank connection space 4, and the secondary enclosure 7 under the deck 12.

According to an embodiment, the method may further comprise ventilating the first space 8 via the first ventilation inlet 13 and the first ventilation outlet 15 by at least 30 air changes per hour.

1.-56. (canceled)

57. A fuel tank for a marine vessel having a hull and a deck, wherein the fuel tank comprises:
a gas tight manhole provided on an upper portion of the fuel tank and configured to be accessed from above the fuel tank in a use position of the fuel tank to provide access to the fuel tank, the fuel tank being a single shell fuel tank;
a tank connection space provided at an end or on a side of the fuel tank, which tank connection space includes a gas tight compartment containing tank penetrations and tank valves for fuel; and
secondary enclosure covering the manhole and limiting a first space between the manhole and the secondary enclosure for providing access to the manhole, which first space extends at least around and above of the manhole and forms, when closed, a gas tight compartment isolating the first space from a tank hold space, which tank hold space surrounds the fuel tank, the tank connection space, and the secondary enclosure;
wherein the secondary enclosure is provided with a first ventilation inlet configured to connect the first space to inlet ventilation piping and a first ventilation outlet configured to connect the first space to outlet ventilation piping;
wherein the tank connection space is provided with a second ventilation inlet configured to connect the tank connection space to inlet ventilation piping and a second ventilation outlet configured to connect the tank connection space to outlet ventilation piping;
wherein an entrance to the tank connection space is provided through a second space, which second space includes a gas tight compartment and is provided with a third ventilation inlet configured to connect the second space to inlet ventilation piping and a third ventilation outlet configured to connect the second space to outlet ventilation piping; and
wherein the manhole and the secondary enclosure each include a gas tight cover, and wherein the gas tight manhole cover and the gas tight secondary enclosure cover are provided one after the other in a direction of travel in a spaced manner.

58. A fuel tank according to claim 57, wherein the outlet ventilation piping is isolated from the tank hold space and configured to guide the outlet air from the first space, from the tank connection space, and from the second space, respectively, to outside air outside the tank hold space.

59. A fuel tank according to claim 58, wherein the first space is configured to be ventilated, via the first ventilation inlet and the first ventilation outlet, at least 10 air changes per hour.

60. A fuel tank according to claim 59, wherein the first ventilation outlet and/or the ventilation outlet piping connected to the first ventilation outlet comprises:
a gas detector configured to detect a leak from the fuel tank to the first space.

61. A fuel tank according to claim 60, wherein the manhole is arranged and configured to be accessed in a vertical direction from above the fuel tank in the use position of the fuel tank; or
wherein the manhole is arranged and configured to be accessed in a direction angled with respect to a vertical direction from above the fuel tank in the use position of the fuel tank.

62. A fuel tank according to claim 61, wherein the manhole cover and the secondary enclosure cover are provided on top of each other in a vertical direction.

63. A fuel tank according to claim 62, wherein at least the secondary enclosure cover comprises:
a maintenance hatch, which is mounted to the secondary enclosure by bolts in a locked manner.

64. A fuel tank according to claim 63, wherein the secondary enclosure cover comprises:
a separate locking device for locking the cover to a closed position.

65. A fuel tank according to claim 63, wherein the secondary enclosure comprises:
a doubling plate configured to be mounted against a shell of the fuel tank, and to conform, at least partly, to a shape of a surface of the shell of the fuel tank.

66. A fuel tank according to claim 65, wherein fuel tank is configured to hold liquified gas.

67. A fuel tank according to claim 65, wherein the volume of the fuel tank is in a range of 100-3000 m3.

68. A marine vessel in combination with the fuel tank according to claim 57, the marine vessel comprising:
a hull;
a deck; and
the fuel tank.

69. A marine vessel according to claim 68, wherein the fuel tank is provided within the hull and below the deck.

70. A marine vessel according to claim 69, wherein the marine vessel comprises, below the deck:
a second fuel tank, wherein the fuel tank and the second fuel tank are provided side by side, and wherein the fuel tanks share, at least partly, a common ventilation.

71. A method for arranging a fuel tank according to claim 57 in a marine vessel, the marine vessel including:
a hull;
a deck; and
the fuel tank, the fuel tank including the tank connection space, wherein the method comprises:
isolating the tank connection space to form a gas tight compartment containing tank penetrations and tank valves for fuel;
providing the secondary enclosure covering the manhole and limiting a first space between the manhole and the secondary enclosure, which first space extends at least around and above of the manhole; and
configuring the secondary enclosure to form, when closed, a gas tight compartment isolating the first space from a tank hold space surrounding the fuel tank, the tank connection space, and the secondary enclosure.

72. A fuel tank according to claim 57, wherein the first space is configured to be ventilated, via the first ventilation inlet and the first ventilation outlet, at least 10 air changes per hour.

73. A fuel tank according to claim 57, wherein the first ventilation outlet and/or the ventilation outlet piping connected to the first ventilation outlet comprises:
a gas detector configured to detect a leak from the fuel tank to the first space.

74. A fuel tank according to claim 57, wherein the manhole is arranged and configured to be accessed in a vertical direction from above the fuel tank in the use position of the fuel tank; or
wherein the manhole is arranged and configured to be accessed in a direction angled with respect to a vertical direction from above the fuel tank in the use position of the fuel tank.

75. A fuel tank according to claim 57, wherein at least the secondary enclosure cover comprises:
a maintenance hatch, which is mounted to the secondary enclosure by bolts in a locked manner.

76. A fuel tank according to claim 57, wherein the secondary enclosure cover comprises:
a separate locking device for locking the cover to a closed position.
